(19) United States
(12) Patent Application Publication
(10) Pub. No.: US 2007/0024664 A1
(43) Pub. Date: Feb. 1, 2007

(54) Methods and apparatus for concurrent inkjet printing and defect inspection

(75) Inventors: Quanyuan Shang, Saratoga, CA (US); Robert Bachrach, Burlingame, CA (US)

Correspondence Address: DUGAN & DUGAN, PC, 55 SOUTH BROADWAY, TARRYTOWN, NY, 10591, US

(73) Assignee: Applied Materials, Inc., Santa Clara, CA (US)

(21) Appl. No.: 11/493,861

(22) Filed: Jul. 25, 2006

Related U.S. Application Data
(60) Provisional application No. 60/703,146, filed on Jul. 28, 2005.

(51) Int. Cl. B41J 29/393

(52) U.S. Cl. 347/19

(57) ABSTRACT

A system for concurrent inkjet printing and defect inspection is provided. The system includes at least one print head adapted to deposit ink on a substrate, at least one imaging device adapted to scan the substrate, and a controller adapted to receive image data scanned by the imaging device during printing, determine if there are any printing defects on the substrate utilizing the processed image data, and transmit a control signal indicating a disposition of the substrate. The imaging device is adapted to scan the substrate during each print pass. Numerous other aspects are also disclosed.

This application claims priority from U.S. Provisional Patent Application Ser. No. 60/703,146, filed Jul. 28, 2005 which is hereby incorporated by reference herein in its entirety.

### FIELD OF THE INVENTION

The present invention relates generally to electronic device manufacturing and systems for printing, and is more particularly concerned with apparatus and methods for detecting defects while printing color filters.

### BACKGROUND OF THE INVENTION

The flat panel display industry has been attempting to employ inkjet printing to manufacture display devices, and in particular, color filters for flat panel displays. Because the pixel wells into which ink is deposited when printing patterns for color filters may be particularly small, the possibility of defects is significant. Thus, efficient methods and apparatus for avoiding and detecting defects are desirable.

### SUMMARY OF THE INVENTION

In some embodiments of the invention, a system for concurrent inkjet printing and defect inspection is provided. The system includes at least one print head adapted to deposit ink on a substrate, at least one imaging device adapted to scan the substrate, and a controller adapted to receive image data scanned by the imaging device during printing, determine if there are any defects on the substrate utilizing the processed image data, and transmit a control signal indicating a disposition of the substrate. The imaging device is adapted to scan the substrate during each print pass.

In the same or other aspects of the invention, a method for simultaneous inkjet printing and defect inspection is provided. The method includes depositing ink on a substrate with at least one inkjet print head, scanning the substrate with an imaging device during printing, processing image data scanned by the imaging device, determining if there are any defects on the substrate by utilizing the processed image data, and transmitting a control signal indicating a disposition of the substrate.

Other features and aspects of the present invention will become more fully apparent from the following detailed description, the appended claims, and the accompanying drawings.

### BRIEF DESCRIPTION OF THE DRAWINGS

FIG. 1A is a top schematic view of an inkjet printing and defect inspection system according to some embodiments of the present invention.

FIG. 1B is a perspective view of an inkjet printing and defect inspection system according to some embodiments of the present invention.

FIG. 2 is a close-up view of an inkjet printing and defect inspection apparatus according to some embodiments of the present invention.

FIG. 3 is an image of example print defects which may be detected by an inkjet printing and defect inspection system according to some embodiments of the present invention.

FIG. 4 is a flowchart illustrating an example of a method of inkjet printing and defect inspection according to some embodiments of the present invention.

### DETAILED DESCRIPTION

The present invention provides methods and apparatus for concurrently inkjet printing and performing defect inspection. The inventors of the present invention have recognized that a problem with effective employment of inkjet printing in manufacturing, e.g., color filters for flat panel displays, is that it may be inefficient to inspect printed display devices after the entire device has been printed. According to the present invention, an inspection system capable of detecting inkjet printing defects (e.g., inadequately filled pixel wells, ink on the pixel well barriers (e.g., black matrix), incorrect ink color in a well, contaminant particles in a well, etc.) on a substrate during printing may be provided in an inkjet print system.

In some embodiments, the inspection system may include one or more cameras positioned at or near the inkjet print heads. Each inkjet print head may have an associated camera. Alternatively, multiple cameras may be clustered at a single inkjet print head or may be located away from the inkjet print heads. The cameras may scan a substrate as ink is being deposited and determine the print quality and/or may pass scanned data along with location data to a controller for image processing. The inspection system may scan a prior pass or group of passes. That is, if a camera is mounted adjacent an inkjet print head, the camera can scan a previously printed column of pixel wells as the inkjet print head deposits ink in the current column of pixel wells. Additionally or alternatively, location coordinates (e.g., on an XY plane) of the scanned region and/or defect locations may be passed to the controller or may be recorded along with other images and/or associated image data. The inventive inspection system may also employ various color filters and/or image enhancements to increase image contrast and more readily identify defects. The inspection system of the present invention may be capable of scanning the print in real time and issuing control signals to stop or hold printing if print defects are found.

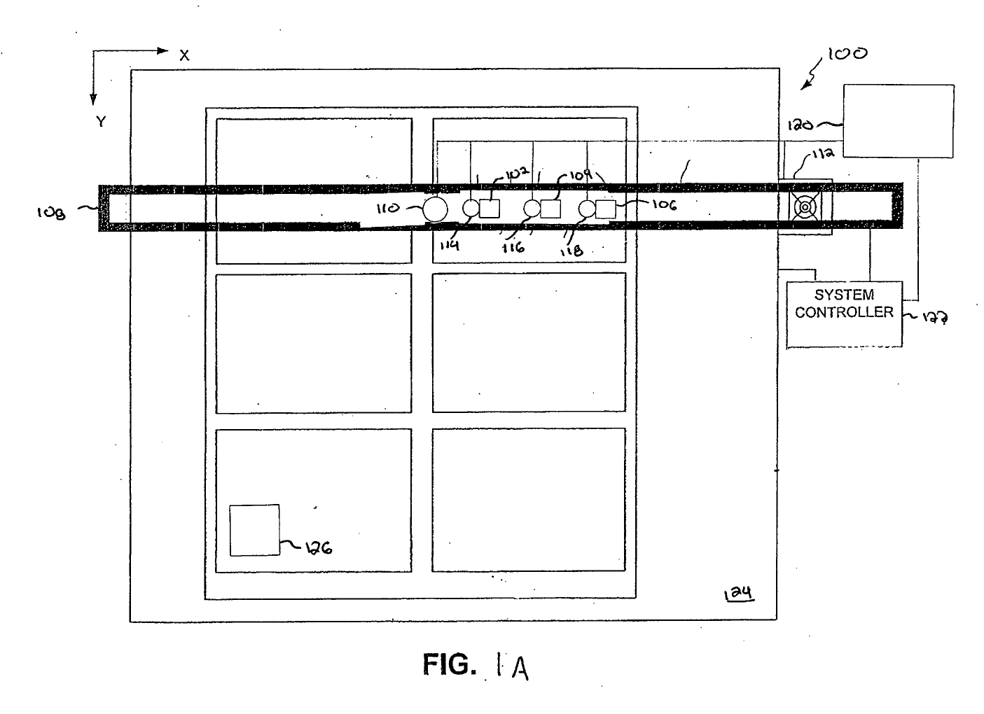

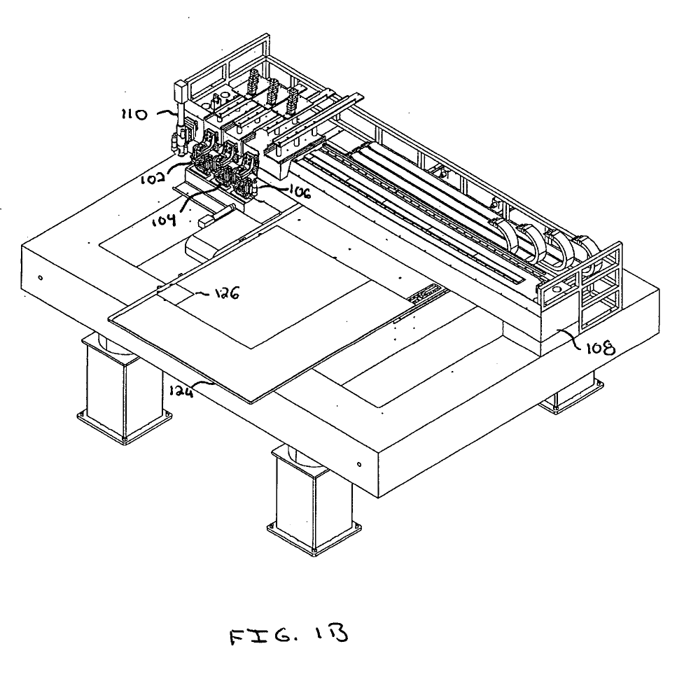

FIG. 1A illustrates a top schematic view and FIG. 1B illustrates a perspective view of an embodiment of an inkjet printing and defect inspection system of the present invention which is designated generally by the reference numeral 100. The inkjet printing and defect inspection system 100 of the present invention, in an exemplary embodiment, may include print heads 102, 104, 106. Print heads 102-106 may be supported on a print bridge or support 108. Print bridge 108 may also support imaging systems 110 and/or 112 and/or 114, 116, and 118. Imaging systems 110-118 may be coupled to an imaging system controller 120 (FIG. 1A). The imaging system controller 120 may be logically (e.g., electrically, wirelessly, optically, etc.) and/or mechanically coupled to the imaging systems 110-118. Similarly, print heads 102-106 and print bridge 108 may be coupled to a system controller 122. The system controller 122 may be logically (e.g., electrically) and/or mechanically coupled to the print heads 102-106 and print bridge 108. In some embodiments, the imaging system controller 120 may be directly coupled to, in communication with, and/or under the control of the system controller 122. In additional or alternative embodiments, the imaging system controller 120 and the system controller 122 may be one in the same. The inkjet printing and defect inspection system 100 may also include a stage 124 which may include a light source 126.

In the exemplary embodiments of FIGS. 1A and 1B, the print bridge 108 may support print heads 102-106. Although three print heads are shown on print bridge 108 in FIGS. 1A and 1B, it is important to note that any number of print heads may be mounted on and/or used in connection with the print bridge 108 (e.g., 1, 2, 4, 5, 6, 7, etc. print heads). Print heads 102-106 may be capable of dispensing a single color of ink or, in some embodiments, may be capable of dispensing multiple colors of ink.

The inkjet printing and defect inspection system 100 of the present invention may include any number of imaging systems 110-118 (e.g., 1, 2, 3, 4, 5, 6, etc.). Exemplary imaging systems for use in an inkjet print system are described in U.S. patent application Ser. No. 11/019,930, filed Dec. 22, 2004 and entitled “METHODS AND APPARATUS FOR ALIGNING PRINT HEADS” which is hereby incorporated by reference herein in its entirety. Similarly, imaging systems 110-118 may include one or more high resolution digital line scan cameras, CCD-based cameras, and/or any other suitable cameras. An exemplary imaging system for use in the present invention may incorporate an objective lens capable of multiple times zoom with approximately 8000 pixels and a 5 um pixel resolution. The exemplary imaging system may also have a 100 KHz line rate and may be capable of scanning the substrate at 500 mm/second. Cameras having other characteristics may also be used. In at least one embodiment, the imaging systems 110-118 may be capable of inspecting three colors (e.g., red, green, and blue) at the same time.

In a first exemplary embodiment, the imaging system 110 may be coupled to the print bridge 108 in a position and manner similar to that used for a print head. That is, the imaging system 110 may be capable of similar rotation and movement as the print heads 102-106 and may be moved adjacent the print heads 102-106 or may be spaced apart from them. The imaging system 110 may include a single camera or, in some embodiments, multiple cameras (e.g., 2, 3, etc.) in a cluster. In some embodiments, one camera may be capable of detecting defects relating to blue and/or green ink and one camera may be capable of detecting defects relating to red ink. In other embodiments, each camera may be capable of detecting defects relating to different ink colors and sufficient numbers of cameras may be provided so as to have one camera for each ink color. Imaging system 110 may be positioned on either side of the print heads 102-106 or may be positioned interstitially.

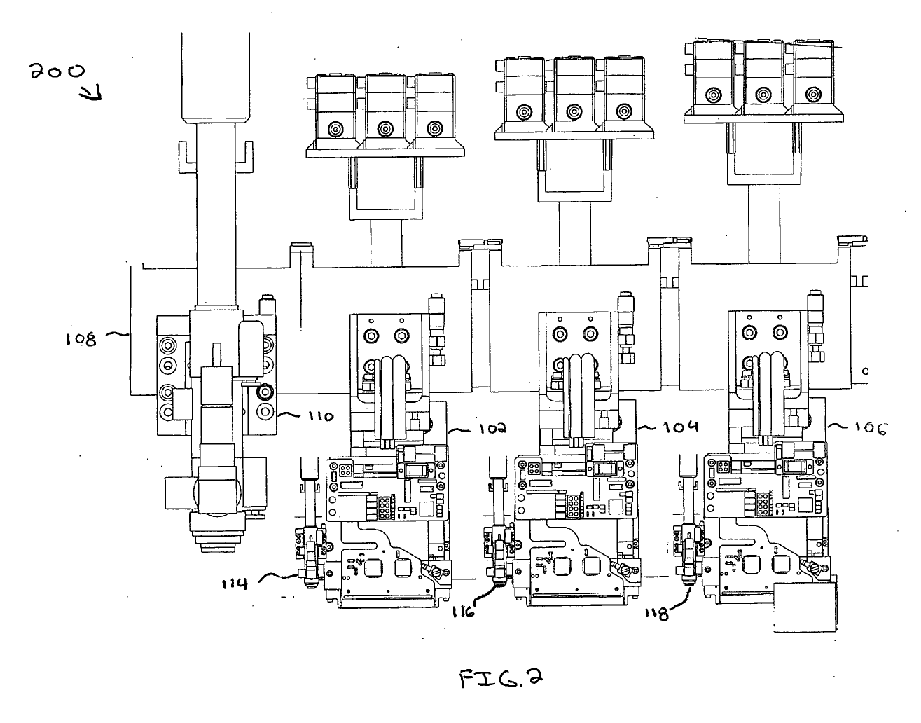

In one or more embodiments, imaging system 110 may be positioned to the left of the print heads 102-106 (e.g., as shown in FIGS. 1A, 1B, and 2). With the imaging system 110 positioned to the left of the print heads 102-106 and the print pass proceeding from left to right (e.g., ink is deposited into a column of pixel wells on a substrate, followed by the stage shifting to the left in preparation for the next print pass), the imaging system will first capture images from the column of pixel wells just printed. In some embodiments, the imaging system 110 may also be capable of capturing images from previous print passes, the most recently printed pass, and/or the current print pass. Imaging system 110 may be positioned to capture images of the substrate located directly beneath the associated camera (e.g., able to view print passes previously printed). Alternatively, imaging system 110 may be angled to capture images of a print pass in progress or may be angled in any direction to capture images of various portions of the substrate.

In a second exemplary embodiment, the imaging system 112 of FIG. 1A may be coupled directly to and supported by the print bridge 108. This coupling location may be adjacent the print heads 102-106 or may be located elsewhere on the print bridge 108. The imaging system 112 may include a single camera or, in some embodiments, multiple cameras in a cluster. Further, the imaging system 112 may be a standard microscope camera, as opposed to the high speed cameras 114-118 used for scanning the substrate while in motion, that is provided to allow an operator to closely examine a particular location or defect while the substrate is stationary. For example, once the scanning imaging systems 114-118 identify a potential defect at a particular XY position, printing may be stopped and the imaging system 112 may be moved to the particular XY location to allow an operator to examine the location in detail and assess the potential defect.

In a third exemplary embodiment, the imaging systems 114-118 may be attached to and adjacent the print heads 102-106. That is, imaging system 114 may be separately mounted on print bridge 108 immediately adjacent print head 102 or may be mounted to the same assembly as print head 102 such that any movement by print head 102 will coincide with (e.g., cause) movement of imaging system 114. Similarly, imaging system 116 may be mounted with or adjacent print head 104 and imaging system 118 may be mounted with or adjacent print head 106. In some embodiments, imaging systems 114-118 may each include a camera capable of capturing images of pixel wells printed with the ink dispensed by their corresponding print heads 102-106. Each print head 102-106 may have an associated imaging system 114-116.

In embodiments where each print head 102-106 has a corresponding imaging system 114-118, each imaging system 114-116 may view a different spatial image. For example, during a printing operation where the printing proceeds from left to right, imaging system 118 may capture images of a printed column of pixel wells and two adjacent unfilled pixel wells. The imaging system 116 may capture images of two filled columns of pixel wells and one unfilled column. Imaging system 114 may capture images of three filled columns.

Alternatively, imaging systems 114-118 may include more than one camera such that cameras are clustered at one or more print heads 102-106 and one or more print heads do not have an associated imaging system 114-118. For example, in some embodiments, print head 102 may have an imaging system 114 mounted along with the print head. The imaging system 114 may include two or more cameras, each capable of detecting certain color defects. Print heads 104, 106 may not include an imaging system 116, 118. When two cameras are incorporated in imaging system 114, one camera may be adapted to detect blue/green ink defects and one camera may be adapted to detect red ink defects. The cameras may be adapted for specific colors, for example, by using color filters. When three cameras are incorporated in imaging system 114, each camera may be capable of detecting defects in different ink colors for added discrimination between printed colors.

Imaging systems 110-118 may be coupled to the imaging system controller 120 logically (e.g., electrically, wirelessly, optically, etc.) and/or mechanically. The imaging system controller 120 may include software capable of processing images captured by the imaging systems 110-118. The imagining system controller 120 may be capable of processing and/or storing image data received from each imaging system 110-118. Alternatively, each imaging system 110-118 may have an associated imaging system controller (e.g., each imaging system 110-118 may be capable of processing and/or storing image data). The image data transmitted from the imaging systems 110-118 may include location coordinates (e.g., on an XY plane) of the scanned region, defect locations and/or types, and/or images. The location data may also be retrieved or received from the printing system (e.g., system controller 122). In some embodiments, to save processor function, only images containing probable defects are transmitted to the imaging system controller 120.

The imaging system controller 120 may be capable of receiving the transmitted image data from the imaging systems 110-118, processing the image data, and determining a disposition of the substrate based on the image data (e.g., pausing or stopping printing, sending the substrate to be cleaned, sending the substrate to final disposal, sending the substrate for other repair, passing printing and allowing printing to continue, etc.).

The imaging system controller 120 may be any suitable computer or computer system, including, but not limited to, a mainframe computer, a minicomputer, a network computer, a personal computer, and/or any suitable processing device, component, or system. The imaging system controller 120 alternatively may comprise a dedicated logic circuit or any suitable combination of hardware and/or software. The imaging system controller 120 may be adapted to control any of the imaging systems 110-118, including controlling the movement of each imaging system 110-118 rotationally and in both positive and negative lateral displacement directions along the X-axis; the positive X-axis direction being indicated by the frame of reference arrow labeled X in FIG. 1A. Additionally, the imaging system controller 120 may be capable of controlling the angle of the imaging systems 110-118 relative to the substrate, the optical or electronic zoom, the distance of the imaging systems 110-118 from the substrate, or perform any other control necessary.

As noted above, the system 100, in an exemplary embodiment, may include the system controller 122. As with the imaging system controller 120, the system controller 122 may be any suitable computer or computer system, including, but not limited to, a mainframe computer, a minicomputer, a network computer, a personal computer, and/or any suitable processing device, component, or system. The system controller 122 alternatively may comprise a dedicated logic circuit or any suitable combination of hardware and/or software. The system controller 122 may be adapted to control any of the print heads 102-106 through the print support 108, including controlling the movement of each print head 102-106 rotationally and in both positive and negative lateral displacement directions along the X-axis; the positive X-axis direction being indicated by the frame of reference arrow labeled X in FIG. 1A. The system controller 122 may also control any and all inkjet printing and maintenance operations capable of being performed by the print support 108, and/or the print heads 102-106.

The system controller 122 may interface with the imaging system controller 120 and/or may communicate directly with the imaging systems 110-118. Either the imaging system controller 120 or the system controller 122 may determine a disposition of the substrate based on the received and/or processed image data. Based on the disposition of the substrate, either the imaging system controller 120 or the system controller 122 may send control signals to associated components of inkjet printing and defect inspection system 100 to perform some action on the substrate. This action may include pausing or stopping printing, sending the substrate to be cleaned, sending the substrate to final disposal, sending the substrate for other repair, or qualifying printing as acceptable and allowing printing and/or the substrate to continue or to be passed to the next phase of manufacture.

The inkjet printing and defect inspection system 100 may also include one or more light sources 126 (as shown in FIGS. 1A and 1B) disposed on, near, above and/or below the stage 124. The light source 126 may provide light to be passed through the substrate to aid in the highlighting and detection of print defects. The light source 126 may be a moveable linear light source. The light source 126 may also be an optical fiber guide such as a white fluorescence source or quartz halogen source, an LCD backlight, or an LED light. Any other suitable light source may be used. By incorporating light source 126, the inkjet printing and defect inspection system 100 may detect color region thickness variation by detecting variation in transmittance light intensity.

FIG. 2 depicts a close-up view of an exemplary embodiment of an apparatus according to the present invention. Inkjet printing and defect inspection apparatus 200 may include print heads 102, 104, and 106 mounted on print support or bridge 108. Also mounted on print bridge 108, in a position and manner similar to those shown in FIGS. 1A and 1B, may be imaging systems 110, 114, 116, and 118. Imaging system 110 may be movable, rotatable, and angleable in such ways as to allow the system to view a current or prior printing pass. In an alternative embodiment, imaging systems 114-118 may be mountable in the same mount as any of print heads 102-106 or to the print heads 102-106 themselves and may be similarly movable, rotatable, and angleable. Imaging systems 114-118 may be mounted on any side of print heads 102-106 to view current, prior, and future print operations. For example, an imaging system 114 mounted to the left of print head 102 may be capable of capturing images of the prior print pass or passes. If imaging system 114 were mounted on the right side of print head 102, the imaging system 114 may be capable of capturing images of the prior print pass or passes of print head 104. Imaging systems 114-118 may also be mounted fore and/or aft of any of print heads 102-106 relative to the print direction (which may be both positive and negative directions along the Y-axis, the positive Y-axis direction being indicated by the frame of reference arrow labeled Y in FIG. 1A). In this configuration, imaging systems 114-118 may be capable of capturing images of defects in the substrate before a print operation and/or immediately following the dispensing of ink (thus not having to wait until an entire print pass is completed).

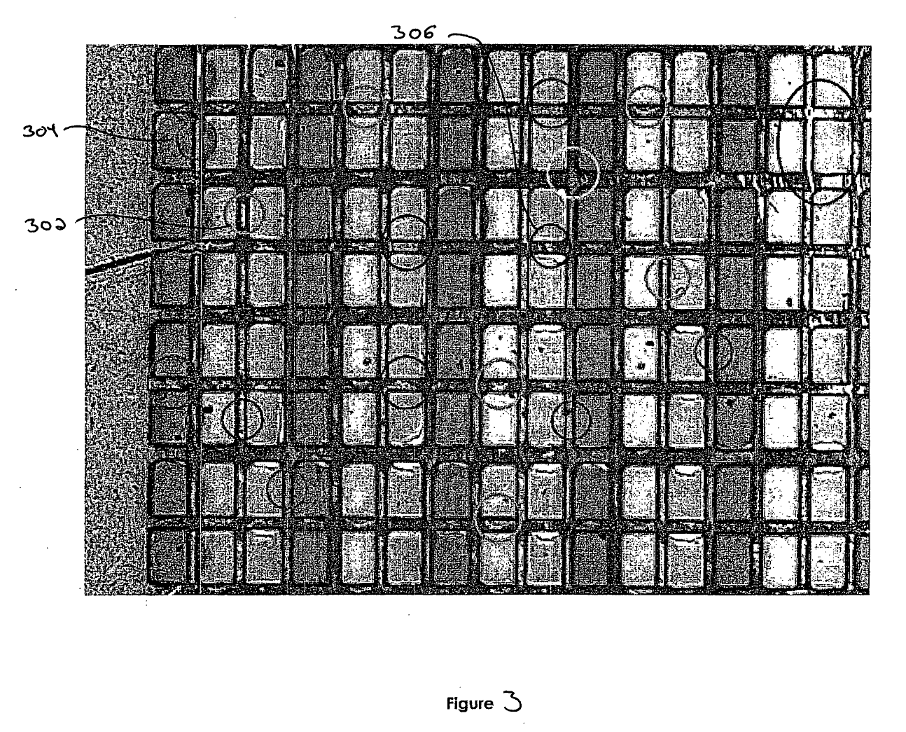

FIG. 3 is an image of example print defects (encircled) which may be detected by the present invention. Possible print defects, for example, may include ink on barriers between pixel wells (302), incorrect ink color deposited in adjoining pixel wells and mixing of ink color (304), and ink voids (306). Other possible print defects may include contaminant particles in pixel wells, incorrect color deposition, insufficiently filled pixel wells (e.g., less than approximately 0.2 um thickness), overfilled pixel wells, incorrect dimensions, and the like. The inkjet printing and defect inspection system of the present invention may be capable of detecting these and other print defects as they occur during printing.

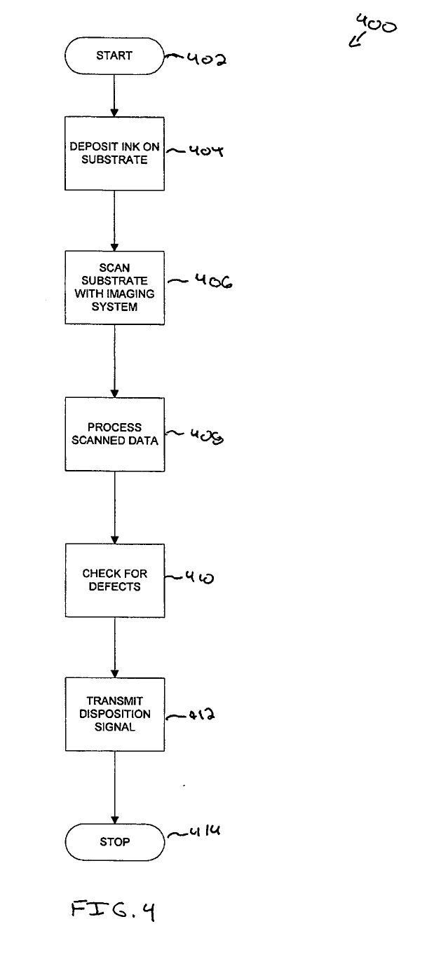

Turning to FIG. 4, a flowchart depicting an example embodiment of a method 400 of inkjet printing and defect inspection according to the present invention is illustrated. For convenience, the method 400 is described with reference to the inkjet printing and defect inspection system 100 of FIGS. 1A-1B. A similar method may be employed with the other inkjet printing and defect inspection systems described herein.

The example method 400 begins at step 402. In step 404, print heads 102-106 may deposit ink on a substrate. Note that in some embodiments, the number of print heads may be different. Print heads 102-106 may deposit ink concurrently or individually and may deposit ink of the same or different colors.

In step 406, imaging systems 110-118 may scan the substrate. To scan the substrate, imaging systems 110-118 may capture an image of the pixel wells previously or currently being printed to and may transmit the image data to imaging system controller 120. The scan rate may be approximately 500 mm/second and may be scanned with a 544 MHz camera module, though any appropriate scan rate and/or camera module may be used. Video and/or snap shot images of the scanned substrate may be displayed or stored at or in the system controller 122 or the imaging system controller 120. In some embodiments, to save memory space and conserve load on the processors, only images and/or data of print defects may be recorded or otherwise acquired. Alternatively, all image data and/or snapshots may be recorded or passed to the imaging system controller 122.

The steps of depositing ink on a substrate and scanning the substrate may occur serially or concurrently in accordance with the system described above. That is, as a print head 102-106 is depositing ink on the substrate, an imaging system 110-118 may be scanning the substrate for print defects.

Following step 406, imaging systems 110-118 and/or imaging system controller 120 may process the scanned images in step 408. Processing the scanned image may include recording defect rates, locations, and/or conditions, identifying known types of defects using pattern recognition algorithms, determining severity and/or acceptability, etc.

In step 410, the processed scanned data may be used to check for printing defects. Imaging system controller 120 may use scanned data and/or images to determine if print defects exist and determine a disposition condition. For example, the disposition condition may be a measure of the degree of printing defect. In some embodiments, imaging processing algorithms may be employed for each imaging system 110-118 to determine the rate, type, and/or severity of defect.

In step 412, based on the disposition of the substrate determined in step 410, either the imaging system controller 120 or the system controller 122 may send control signals to associated components of inkjet printing and defect inspection system 100 (or other systems) to perform some action on the substrate or the inkjet printing and defect inspection system 100. For example, the control signals may indicate that (a) a nozzle on a print head is not working resulting a blank pixel, (b) a print head is misaligned such that inks are filling a neighboring pixel well instead of a target pixel well, (c) printed pixel wells include voids indicating that the drop size/volume is set too low, etc. Resulting actions may include pausing or stopping printing, sending the substrate to be cleaned, sending the substrate to final disposal, sending the substrate for other repair, cleaning the print head, replacing the print head, realigning the print head, passing printing and allowing printing and/or the substrate to continue or to be passed to the next phase of manufacture and/or the like. The method ends at step 414.

The foregoing description discloses only particular embodiments of the invention; modifications of the above disclosed methods and apparatus which fall within the scope of the invention will be readily apparent to those of ordinary skill in the art. Further, although the above example methods are applied to only three print heads 102-106 and five imaging systems 110-118 in FIGS. 1A, 1B, and 2, one of ordinary skill in the art would understand that these methods may be applied to any number of print heads and/or imaging systems. Further, the present invention may also be applied to spacer formation, polarizer coating, and nanoparticle circuit forming.

Accordingly, while the present invention has been disclosed in connection with specific embodiments thereof, it should be understood that other embodiments may fall within the spirit and scope of the invention, as defined by the following claims.

What is claimed is:

1. An apparatus comprising:
at least one print head adapted to deposit ink on a substrate;
at least one imaging device adapted to scan the substrate during a print pass; and
a controller adapted to receive image data scanned by the imaging device, determine if there are any defects on the substrate utilizing the processed image data, and transmit a control signal indicating the disposition of the substrate.

2. The apparatus of claim 1 wherein the print head is adapted to deposit ink of a fist color and wherein the imaging device is adapted to detect defects associated with the ink of the first color.

3. The apparatus of claim 1 wherein the print head and the imaging device are coupled to a print support.

4. The apparatus of claim 1 wherein the imaging device is adapted to scan an area of the substrate printed during a print pass prior to a current print pass.

5. The apparatus of claim 1 wherein the imaging device includes at least two cameras and wherein a first of the two cameras is used to scan the substrate while the substrate is moved in a first direction, and a second of the two cameras is used to scan the substrate while the substrate is moved in a second direction.

6. The apparatus of claim 1 wherein the imaging device includes at least two cameras and wherein a first of the two cameras is adapted to detect defects associated with red ink, and a second of the two cameras is adapted to detect defects associated with blue/green ink.

7. The apparatus of claim 1 wherein the controller is adapted to be able to transmit the control signal indicating that the substrate includes a defect, printing should be stopped, and the print head should receive maintenance.

8. The apparatus of claim 1 further comprising a light source adapted to illuminate the substrate from a side of the substrate opposite a side upon which ink is deposited.

9. A method comprising:
depositing ink on a substrate with at least one inkjet print head;
scanning the substrate with an imaging device;
processing image data scanned by the imaging device;
determining if there are defects on the substrate by utilizing the processed image data; and
transmitting a control signal indicating the disposition of the substrate,
wherein depositing ink and scanning the substrate occur concurrently.

10. The method of claim 9 wherein depositing ink includes depositing ink of a first color and wherein scanning the substrate includes scanning the substrate with the imaging device which is adapted to detect defects associated with the ink of the first color.

11. The method of claim 9 wherein depositing ink and scanning are performed using the print head and the imaging device, respectively, which are both suspended from a print support.

12. The method of claim 9 wherein scanning includes scanning using the imaging device which is adapted to scan an area of the substrate printed during a print pass prior to a current print pass.

13. The method of claim 9 wherein scanning includes scanning using the imaging device which includes at least two cameras and wherein a first of the two cameras is used to scan the substrate while the substrate is moved in a first direction, and a second of the two cameras is used to scan the substrate while the substrate is moved in a second direction.

14. The method of claim 9 wherein scanning includes scanning using the imaging device which includes at least two cameras and wherein a first of the two cameras is adapted to detect defects associated with red ink, and a second of the two cameras is adapted to detect defects associated with blue/green ink.

15. The method of claim 9 wherein transmitting a control signal includes transmitting a control signal that indicates that the substrate includes a defect, printing should be stopped, and the print head should receive maintenance.

16. The method of claim 9 further comprising illuminating the substrate from a side of the substrate opposite a side upon which ink is deposited.

17. A method comprising:
depositing ink on a substrate with at least one inkjet print head;
scanning the substrate with an imaging device during at least a portion of the depositing step; and
determining if there are defects on the substrate based at least in part on the scanning step.

18. The method of claim 17 wherein depositing includes depositing ink of a first color and wherein scanning includes scanning the substrate with the imaging device which is adapted to detect defects associated with the ink of the first color.

19. The method of claim 17 wherein depositing and scanning are performed using the print head and the imaging device, respectively, which are both suspended from a print support.

20. The method of claim 17 wherein scanning includes scanning using the imaging device which is adapted to scan an area of the substrate printed during a print pass prior to a current print pass.

21. The method of claim 17 wherein scanning includes scanning using the imaging device which includes at least two cameras and wherein a first of the two cameras is used to scan the substrate while the substrate is moved in a first direction, and a second of the two cameras is used to scan the substrate while the substrate is moved in a second direction.

22. The method of claim 17 wherein scanning includes scanning using the imaging device which includes at least two cameras and wherein a first of the two cameras is adapted to detect defects associated with red ink, and a second of the two cameras is adapted to detect defects associated with blue/green ink.

23. The method of claim 17 wherein transmitting a control signal includes transmitting a control signal that indicates that the substrate includes a defect, printing should be stopped, and the print head should receive maintenance.

24. The method of claim 17 further comprising illuminating the substrate from a side of the substrate opposite a side upon which ink is deposited.

25. An inkjet printing system comprising:
a plurality of print heads each adapted to deposit a different color ink on a substrate;
a stage adapted to move the substrate past the print heads during printing;
a print bridge adapted to support the print heads above the substrate;
at least one imaging device adapted to scan the substrate during a print pass;
an imaging controller adapted to receive image data scanned by the imaging device, determine if there are any defects on the substrate utilizing the processed image data, and transmit a control signal indicating the disposition of the substrate; and
a system controller adapted to receive the control signal and operate the inkjet printing system in response to the control signal.

26. The system of claim 25 wherein the imaging device is adapted to detect defects associated with the different color inks.

27. The system of claim 25 wherein the print heads and the imaging device are both supported by the print bridge.

28. The system of claim 25 wherein the imaging device is adapted to scan an area of the substrate printed during a print pass prior to a current print pass.

29. The system of claim 25 wherein the imaging device includes at least two cameras and wherein a first of the two cameras is used to scan the substrate while the substrate is moved in a first direction by the stage, and a second of the two cameras is used to scan the substrate while the substrate is moved in a second direction by the stage.

30. The system of claim 25 wherein the imaging device includes at least two cameras and wherein a first of the two cameras is adapted to detect defects associated with red ink, and a second of the two cameras is adapted to detect defects associated with blue/green ink.

31. The system of claim 25 wherein the imaging controller is adapted to be able to transmit the control signal to the system controller indicating that the substrate includes a defect, printing should be stopped, and the print head should receive maintenance.

32. The system of claim 25 further comprising a light source adapted to illuminate the substrate from below the substrate.
